(19) United States
(12) Patent Application Publication
(10) Pub. No.: US 2026/0316505 A1
(43) Pub. Date: Oct. 15, 2026

(54) METHODS AND APPARATUS TO ADJUST DYNAMIC PROPERTIES OF A SUSPENSION SYSTEM OF A VEHICLE

(71) Applicant: Ford Global Technologies, LLC, Dearborn, MI (US)

(72) Inventors: Keith Weston, Canton, MI (US); Kadie Renee Hartman, Berkley, MI (US); Timothy David Smith, Brighton, MI (US); Christopher Michael Paiva, Novi, MI (US); William Brenden Johnson, Allen Park, MI (US)

(21) Appl. No.: 19/175,609

(22) Filed: Apr. 10, 2025

(51) Int. Cl. B60G 9/02

(52) U.S. Cl. CPC B60G 9/02; B60G 2200/315; B60G 2204/42; B60G 2204/422; B60G 2206/11

(57) ABSTRACT

Methods and apparatus to adjust dynamic properties of a suspension system of a vehicle are disclosed. An example apparatus includes a radius arm coupled between a vehicle frame and a wheel axle of a vehicle, a first end of the radius arm coupled to the vehicle frame, a second end of the radius arm coupled to a first location on the wheel axle, and a link coupled between the radius arm and the wheel axle, a third end of the link coupled to the radius arm, a fourth end of the link coupled to the wheel axle at a second location on the wheel axle, the second location adjustable via at least one of (a) a cam bolt coupled between the fourth end of the link and the wheel axle or (b) multiple attachment points on the wheel axle.

### FIELD OF THE DISCLOSURE

This disclosure relates generally to vehicle suspensions and, more particularly, to methods and apparatus to adjust dynamic properties of a suspension system of a vehicle.

### BACKGROUND

Vehicle suspension systems are used to dampen and/or reduce undesired oscillations of a vehicle caused by, for instance, irregularities and/or uneven terrain on a road surface. Vehicle suspension systems typically include one or more components, such as a radius arm (e.g., a lower control arm), coupled to at least one of a vehicle frame or a wheel axle of the vehicle. In some cases, one or more dynamic properties of the vehicle suspension system are based on positions of the one or more components relative to one another and/or to the wheel axle.

### SUMMARY

An example apparatus disclosed herein includes a radius arm coupled between a vehicle frame and a wheel axle of a vehicle. A first end of the radius arm is coupled to the vehicle frame, and a second end of the radius arm is coupled to a first location on the wheel axle. The apparatus also includes a link coupled between the radius arm and the wheel axle. A third end of the link is coupled to the radius arm, and a fourth end of the link is coupled to the wheel axle at a second location on the wheel axle. The second location is adjustable via at least one of (a) a cam bolt coupled between the fourth end of the link and the wheel axle or (b) multiple attachment points on the wheel axle, the multiple attachment points spaced apart in a longitudinal direction of the wheel axle.

A second example apparatus disclosed herein includes a radius arm coupled between a vehicle frame and a first location on a wheel axle of a vehicle, and a link coupled between the radius arm and a second location on the wheel axle. The first location is offset from the first location in a longitudinal direction of the wheel axle and in a transverse direction of the wheel axle.

A third example apparatus disclosed herein includes a radius arm coupled between a vehicle frame and a first location on a wheel axle of a vehicle, a link coupled between the radius arm and a second location on the wheel axle, the second location different from the first location, and one or more cam bolts coupled between at least one of (a) the link and the second location or (b) the link and the radius arm. The one or more cam bolts enable adjustment of a position of the link with respect to the wheel axle and the radius arm.

### BRIEF DESCRIPTION OF THE DRAWINGS

FIG. 1 illustrates an example vehicle in which examples disclosed herein may be implemented.

FIG. 2 illustrates an example front suspension that may be implemented in the example vehicle of FIG. 1.

FIG. 3 is a front view of the suspension system of FIG. 2.

FIG. 4A is a schematic representation of the suspension system of FIGS. 2 and/or 3 in a first splayed configuration.

FIG. 4B is a schematic representation of the suspension system of FIGS. 2 and/or 3 in a second splayed configuration.

FIG. 5 is a side view of a third example linkage that may be implemented in the example suspension system of FIGS. 2, 3, 4A, and/or 4B.

FIG. 6A is a side view of a fourth example linkage that may be implemented in the example suspension system of FIGS. 2, 3, 4A, and/or 4B, with the fourth linkage in a first example configuration.

FIG. 6B is a side view of the fourth example linkage of FIG. 6A in a second example configuration.

FIG. 6C is a side view of the fourth example linkage of FIGS. 6A and/or 6B in a third example configuration.

FIG. 7 is a side view of a fifth example linkage that may be implemented in the example suspension system of FIGS. 2, 3, 4A, and/or 4B.

FIG. 8A is a side view of a sixth example linkage that may be implemented in the example suspension system of FIGS. 2, 3, 4A, and/or 4B.

FIG. 8B is a side view of a seventh example linkage that may be implemented in the example suspension system of FIGS. 2, 3, 4A, and/or 4B.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

As used herein, the orientation of features is described with reference to a lateral axis, a vertical axis, and a longitudinal axis of the vehicle associated with the features. As used herein, the longitudinal axis of the vehicle is parallel to a centerline of the vehicle. The terms “rear” and “front” are used to refer to directions along the longitudinal axis closer to the rear of the vehicle and the front of the vehicle, respectively. As used herein, the vertical axis of the vehicle is perpendicular to the ground on which the vehicle rests. The terms “below” and “above” are used to refer to directions along the vertical axis closer to the ground and away from the ground, respectively. As used herein, the lateral axis of the vehicle is perpendicular to the longitudinal and vertical axes and is generally parallel to the axles of the vehicle. As used herein, the terms “longitudinal,” and “axial” are used interchangeably to refer to directions parallel to the longitudinal axis. As used herein, the terms “lateral” and “horizontal” are used to refer to directions parallel to the lateral axis. As used herein, the term “vertical” is used to refer to directions parallel to the vertical axis.

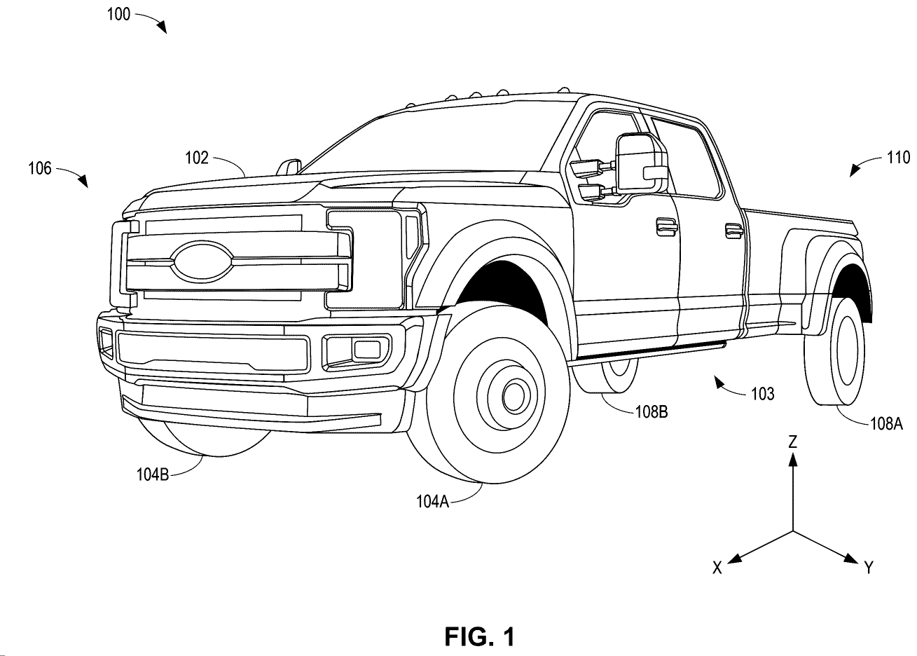

FIG. 1 illustrates an example vehicle 100 in which examples disclosed herein can be implemented. In the illustrated example of FIG. 1, the vehicle 100 is a pick-up truck. In some examples, the vehicle 100 can be a different type of vehicle (e.g., a sedan, a coupe, a van, a sports utility vehicle (SUV), an all-terrain vehicle (ATV), farming equipment, etc.). The vehicle 100 of FIG. 1 includes a vehicle body 102 supported by (e.g., coupled to) a vehicle frame 103, a first front wheel 104A and a second front wheel 104B proximate a front portion 106 of the vehicle 100, and a first rear wheel 108A and a second rear wheel 108B proximate a rear portion 110 of the vehicle 100.

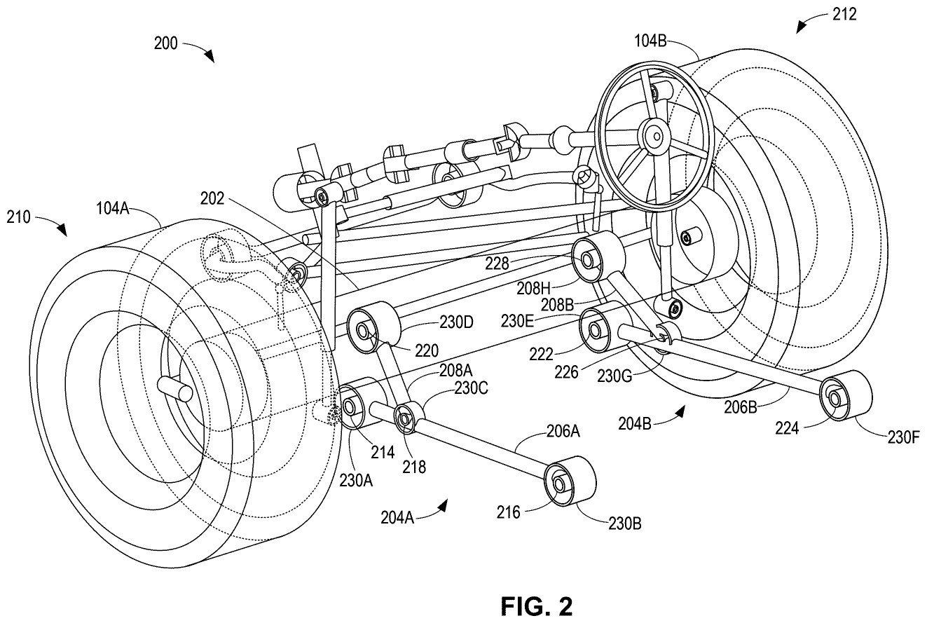

FIG. 2 is a perspective view of an example suspension system (e.g., a vehicle suspension system, a front suspension system) 200 constructed in accordance with teachings of this disclosure. In some examples, the suspension system 200 can be implemented in the vehicle 100 of FIG. 1 to reduce oscillations of the vehicle 100 caused by, for example, irregularities, obstacles, and/or uneven terrain on a road surface. In the illustrated example of FIG. 2, the suspension system 200 is operatively coupled to the front wheels 104A, 104B, and the front wheels 104A, 104B are coupled to respective ends of a wheel axle (e.g., a front axle) 202. In this example, the suspension system 200 includes a first linkage 204A including a first radius arm (e.g., a first lower control arm, a first trail link) 206A and a first link (e.g., a first auxiliary link, a first support link) 208A, and a second linkage 204B including a second radius arm (e.g., a second lower control arm, a second trail link) 206B and a second link (e.g., a second auxiliary link, a second support link) 208B.

In the illustrated example of FIG. 2, the suspension system 200 is mirrored between a left side 210 and a right side 212 of the suspension system 200, such that the first linkage 204A mirrors the second linkage 204B across a longitudinal plane of the vehicle 100 of FIG. 1. In this example, the first radius arm 206A of the first linkage 204A includes a first end 214 coupled to the wheel axle 202 at a first location of the wheel axle 202, and a second end 216 (e.g., opposite the first end 214) couplable to the vehicle frame 103 of the vehicle 100 of FIG. 1. The first link 208A of the first linkage 204A includes a third end 218 coupled to the first radius arm 206A between the first end 214 and the second end 216 of the first radius arm 206A, and a fourth end 220 coupled to the wheel axle 202 at a second location of the wheel axle 202 (e.g., different from the first location). Additionally, the second radius arm 206B of the second linkage 204B includes a fifth end 222 coupled to the wheel axle 202 at a third location of the wheel axle 202 (e.g., different from the first location and the second location), and a sixth end 224 couplable to the vehicle frame 103 of the vehicle 100 of FIG. 1. The second link 208B includes a seventh end 226 coupled to the second radius arm 206B between the fifth end 222 and the sixth end 224 of the second radius arm 206B, and an eighth end 228 coupled to the wheel axle 202 at a fourth location of the wheel axle 202 (e.g., different from the first, second, and third locations).

In the illustrated example of FIG. 2, the suspension system 200 includes first, second, third, fourth, fifth, sixth, seventh, and eighth example bushings 230A, 230B, 230C, 230D, 230E, 230F, 230G, 230H (collectively referred to herein as bushings 230) to couple respective components of the suspension system 200. For example, the first bushing 230A is coupled between the first end 214 of the first radius arm 206A and the first location on the wheel axle 202, the second bushing 230B is to be coupled between the second end 216 of the first radius arm 206A and the vehicle frame 103 of FIG. 1, the third bushing 230C is coupled between the third end 218 of the first link 208A and the first radius arm 206A, and the fourth bushing 230D is coupled between the fourth end 220 of the first radius arm 206A and the second location on the wheel axle 202. Further, the fifth bushing 230E is coupled between the fifth end 222 of the second radius arm 206B and the third location on the wheel axle 202, the sixth bushing 230F is to be coupled between the sixth end 224 of the second radius arm 206B and the vehicle frame 103 of FIG. 1, the seventh bushing 230G is coupled between the seventh end 226 of the second link 208B and the second radius arm 206B, and the eighth bushing 230H is coupled between the eighth end 228 of the second link 208B and the fourth location on the wheel axle 202. In some examples, the bushings 230 guide motion and/or reduce friction between the respective radius arms 206A, 206B, the links 208A, 208B, and the wheel axle 202. In some examples, one or more of the bushings 230 of FIG. 2 may be omitted, and/or one or more different constraining devices (e.g., spherical bearings) may be coupled between respective components of the suspension assembly 200 (e.g., in addition to or instead of one(s) of the bushings 230).

In some examples, by implementing the links 208A, 208B, the suspension system 200 can have additional degree(s) of freedom (e.g., compared to some suspension systems having only a single connection between a radius arm and a wheel axle). In some examples, increasing the degree(s) of freedom (e.g., by implementing the links 208A, 208B) can reduce a roll stiffness of the suspension system 200 without affecting and/or altering a caster stiffness (e.g., a caster windup stiffness) of the suspension system 200. As a result, a desired configuration of dynamic properties (e.g., roll stiffness, caster stiffness, etc.) for the suspension system 200 can be achieved more easily (e.g., compared to some other suspension systems) by implementing the links 208A, 208B.

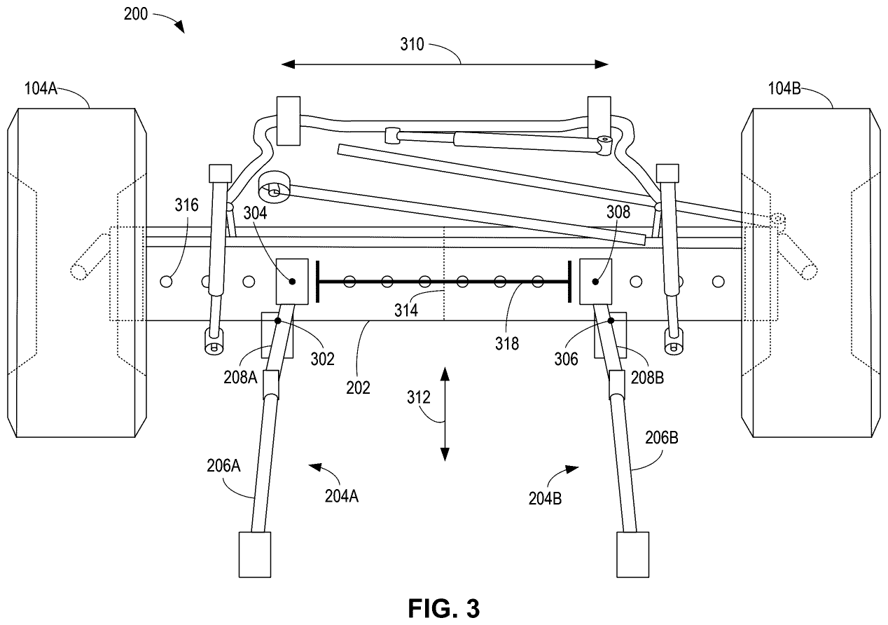

FIG. 3 is a front view of the suspension system 200 of FIG. 2. In the illustrated example of FIG. 3, the first radius arm 206A is coupled to the wheel axle 202 at a first location 302, the first link 208A is coupled to the wheel axle 202 at a second location 304, the second radius arm 206B is coupled to the wheel axle 202 at a third location 306, and the second link 208B is coupled to the wheel axle 202 at a fourth location 308. In this example, the first linkage 204A and the second linkage 204B are in a splayed configuration. Stated differently, the first link 208A is at an angular offset from the first radius arm 206A, and the second link 208B is at an angular offset from the second radius arm 206B. For example, the second location 304 is spaced apart from (e.g., is offset from) the first location 302 relative to a longitudinal direction 310 and a transverse direction 312 of the wheel axle 202 (e.g., the first and second locations 302, 304 are not aligned along a same transverse direction of the wheel axle 202), and the fourth location 308 is spaced apart from (e.g., is offset from) the third location 306 along the longitudinal direction 310 and the transverse direction 312 (e.g., the third and fourth location 306, 308 are not aligned along a same transverse direction of the wheel axle 202). In this example, the second location 304 is inboard with respect to the first location 302, and the fourth location 308 is inboard with respect to the third location 306 (e.g., the second and fourth locations 304, 308 are closer to a longitudinal center (e.g., a midpoint) 314 of the wheel axle 202 compared to the first and third locations 302, 306, the first and third locations 302, 306 are closer to the respective wheels 104A, 104B than the second and fourth locations 304, 308 are to the respective wheels 104A, 104B). Stated differently, a first distance between the first location 302 and the longitudinal center 314 is greater than a second distance between the second location 304 and the longitudinal center 314, and a third distance between the third location 306 and the longitudinal center 314 is greater than a fourth distance between the fourth location 308 and the longitudinal center 314.

In some examples, arranging the linkages 204A, 204B in a splayed configuration (as shown in FIG. 3) can alter and/or improve one or more dynamic properties (e.g., roll stiffness, caster stiffness, single wheel recessional compliance, etc.) of the suspension system 200. For example, reducing a distance 318 between the first link 208A and the second link 208B on the wheel axle 202 can reduce a roll stiffness and/or reduce a caster stiffness associated with the suspension system 200. Conversely, increasing the distance 318 between the first link 208A and the second link 208B on the wheel axle 202 can increase the roll stiffness and/or increase the caster stiffness associated with the suspension system 200. In some examples, adjusting the roll stiffness and/or the caster stiffness can alter vehicle handling of the vehicle 100 and/or responsiveness of the vehicle 100 to impacts (e.g., impacts resulting from the vehicle 100 traversing rough and/or uneven terrain). Additionally, in some examples, the splayed configuration of FIG. 3 can enable rearward movement of an attachment point between the radius arms 206A, 206B and corresponding links 208A, 208B which can, in turn, increase the caster stiffness and/or improve distribution of stresses on the radius arms 206A, 206B.

In some examples, positions at which the first and second links 208A, 208B are coupled to the wheel axle 202 (e.g., the second location 304 and the fourth location 308) can be adjusted to adjust the dynamic properties (e.g., the roll stiffness, the caster stiffness, etc.) of the suspension system 200 and/or the wheel axle 202. For example, the second location 304 and/or the fourth location 308 can be adjusted via multiple example attachment points (e.g., mounting points, attachment locations) 316 spaced apart along the longitudinal direction 310 of the wheel axle 202. In this example, the attachment points 316 are substantially aligned relative to the longitudinal direction 310, and a spacing between adjacent ones of the attachment points 316 is substantially the same across the attachment points 316 (e.g., the attachment points 316 are evenly spaced across a length of the wheel axle 202). In some examples, one or more of the attachment points 316 can be offset relative to the transverse direction 312 from other one(s) of the attachment points 316, and/or a spacing between adjacent ones of the attachment points 316 may be different (e.g., may vary) between the different attachment points 316.

In the illustrated example of FIG. 2, the second location 304 corresponds to a first one of the attachment points 316 and the fourth location 308 corresponds to a second one of the attachment points 316 (e.g., such that the first link 208A is coupled to the wheel axle 202 via the first one of the attachment points 316 and the second link 208B is coupled to the wheel axle 202 via the second one of the attachment points 316). In some examples, to adjust a position (e.g., an orientation, an angular displacement) of the first link 208A relative to the first radius arm 206A, the first link 208A can be moved from the first one of the attachment points 316 to a different one of the attachment points 316 (e.g., such that the second location 304 corresponds to the different attachment point 316). Similarly, to adjust a position (e.g., an orientation, and angular displacement) of the second link 208B relative to the second radius arm 206B, the first link 208A can be moved from the first one of the attachment points 316 to a different one of the attachment points 316 (e.g., such that the second location 304 corresponds to the different attachment point 316). Additionally or alternatively, the first radius arm 206A and/or the second radius arm 206B can be moved to (e.g., coupled to) different ones of the attachment points 316 to adjust the relative positions between the first radius arm 206A and the first link 208A and/or between the second radius arm 206B and the second link 208B. In some examples, a distance (e.g., a spacing) along the longitudinal direction 310 between the first and second locations 302, 304 and/or between the third and fourth locations 306, 308 is at least 20 millimeters and up to 60 millimeters. In some examples, the distance between the first and second locations 302, 304 and/or between the third and fourth locations 306, 308 can be different (e.g., less than 20 millimeters, greater than 60 millimeters).

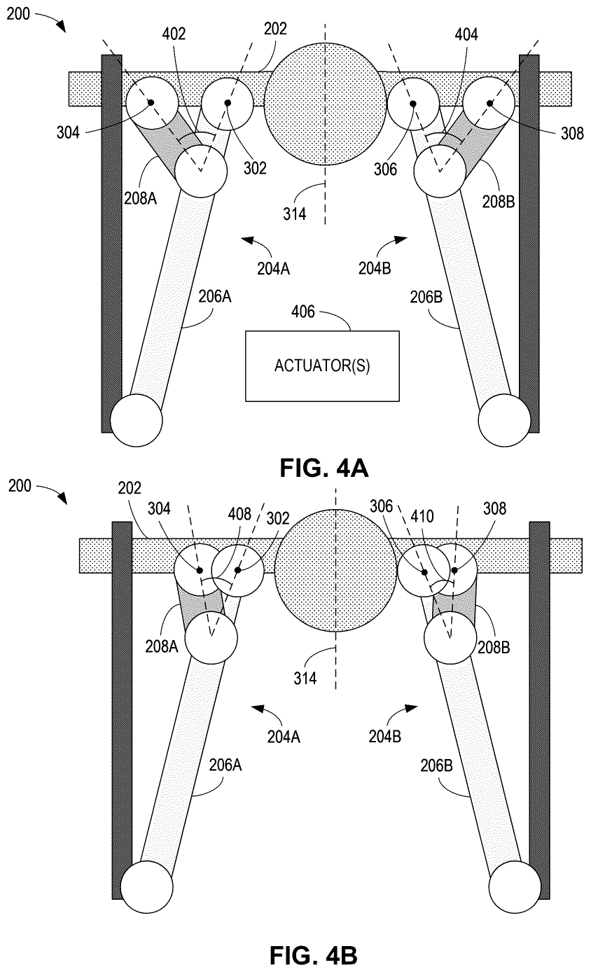

FIGS. 4A and 4B are schematic representations of the suspension system 200 of FIGS. 2 and/or 3 in a first splayed configuration and a second splayed configuration, respectively. For example, the second suspension system 200 can be moved from a first splayed configuration shown in FIG. 3 to the second splayed configuration of FIG. 4A and/or to the third splayed configuration of FIG. 4B by adjusting, via the attachment points 316 of FIG. 3, locations (e.g., the second location 304 and/or the fourth location 308) at which the first link 208A and the second link 208B are coupled to the wheel axle 202 and, as a result, adjusting positions of the first link 208A and the second link 208B relative to the respective first radius arm 206A and the second radius arm 206B.

In the illustrated example of FIG. 4A, in the second splayed configuration, the first linkage 204A is arranged such that the first radius arm 206A is coupled to the wheel axle 202 inboard of the first link 208A (e.g., the first location 302 is closer to the longitudinal center 314 of the wheel axle 202 than the second location 304 is to the longitudinal center 314). Further, the second linkage 204B is arranged such that the second radius arm 206B is coupled to the wheel axle 202 inboard of the second link 208B (e.g., the third location 306 is closer to the longitudinal center 314 of the wheel axle 202 than the fourth location 308 is to the longitudinal center 314). In the illustrated example of FIG. 4A, a first example angle 402 is defined between the first radius arm 206A and the first link 208A, and a second example angle 404 is defined between the second radius arm 206B and the second link 208B. In this example, the first angle 402 is substantially equal to the second angle 404. In some examples, the first angle 402 and the second angle 404 may be different.

In some examples, relative positions between the radius arms 206A, 206B and the respective links 208A, 208B can be adjusted manually.

For example, an operator can couple the radius arms 206A, 206B and/or the links 208A, 208B to different one(s) of the attachment points 316 of FIG. 3 to adjust the relative positions. Additionally or alternatively, one or more example actuators 406 can be coupled (e.g., electrically and/or operatively coupled) to one or more of the links 208A, 208B to adjust the relative positions. For example, the actuator(s) 406 can move one(s) of the links 208A, 208B to increase and/or decrease the respective first angle 402 and/or the second angle 404. In some examples, the actuator(s) 406 and, thus, the relative position(s) between the radius arm(s) 206A, 206B and the respective link(s) 208A, 208B can be controllable via a user interface of the vehicle 100 of FIG. 1, via a mobile device communicatively coupled to the actuator(s) 406, etc. In some examples, the actuator(s) 406 can include at least one of an electromechanical actuator, an electrohydraulic actuator, or an electropneumatic actuator.

In some examples, at least one of the radius arms 206A, 206B and/or the links 208A, 208B can be moved (e.g., manually and/or via the actuator(s) 406) from the second splayed configuration of FIG. 4A to the third splayed configuration of FIG. 4B to adjust one or more dynamic characteristics (e.g., roll stiffness, caster stiffness, etc.) of the suspension system 200. In the illustrated example of FIG. 4B, when the suspension system 200 is in the third splayed configuration, a third example angle 408 is defined between the first radius arm 206A and the first link 208A, where the third angle 408 is less than the first angle 402 of FIG. 4A. Further, a fourth example angle 410 is defined between the second radius arm 206B and the second link 208B, where the fourth angle 410 is less than the second angle 404 of FIG. 4A. In some examples, moving the suspension system 200 from the second splayed configuration of FIG. 4A to the third splayed configuration of FIG. 4B (e.g., by reducing the angles between the radius arms 206A, 206B and the respective links 208A, 208B, by reducing the distance between the first and second locations 302, 304 and/or between the third and fourth locations 306, 308) can reduce a roll stiffness of the suspension system 200. Conversely, increasing the angles between the radius arms 206A, 206B and the respective links 208A, 208B (e.g., increasing the distance between the first and second locations 302, 304 and/or between the third and fourth locations 306, 308) can increase the roll stiffness of the suspension system 200.

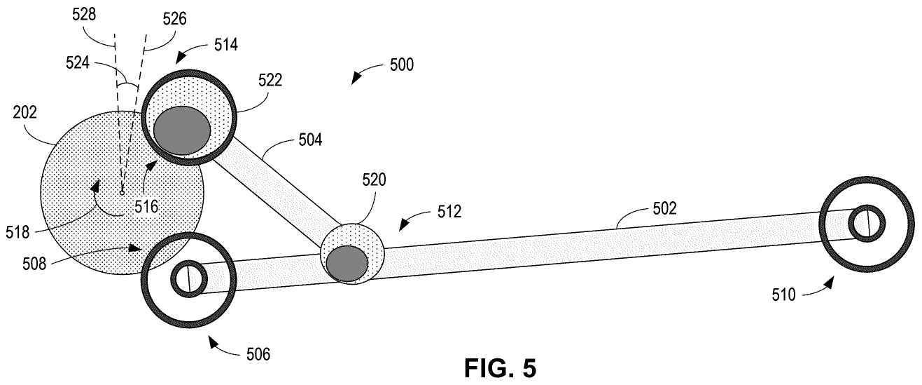

FIG. 5 is a side view of a third example linkage 500 that may be implemented in the example suspension system 200 of FIGS. 2, 3, 4A, and/or 4B (e.g., instead of one(s) of the first linkage 204A and/or the second linkage 204B). In the illustrated example of FIG. 5, the third linkage 500 includes a third example radius arm 502 and a third example link 504 coupled to the wheel axle 202. For example, a first end 506 of the third radius arm 502 is coupled to the wheel axle 202 at a first location 508 of the wheel axle 202, and a second end 510 of the third radius arm 502 is couplable to the vehicle frame 103 of the vehicle 100 of FIG. 1. Further, a third end 512 of the third link 504 is coupled to the third radius arm 502 between the first end 506 and the second end 510, and a fourth end 514 of the third link 504 is coupled to the wheel axle 202 at a second location 516 of the wheel axle 202. In this example, the first location 508 and the second location 516 are spaced apart in a circumferential direction 518 of the wheel axle 202. In some examples, the first location 508 and the second location 516 are on a same circumference of the wheel axle 202. In some examples, the first location 508 and the second location 516 can be on different circumferences of the wheel axle 202 (e.g., the first location 508 and the second location 516 are spaced apart in a longitudinal direction of the wheel axle 202 extending into and/or out of the page in FIG. 5). Stated differently, the third radius arm 502 and the third link 504 can be in a splayed configuration in some examples.

In the illustrated example of FIG. 5, the third linkage 500 includes a first example cam bolt (e.g., a first concentric bolt) 520 coupled between the third end 512 of the third link 504 and the third radius arm 502, and a second example cam bolt 522 coupled between the fourth end 514 of the third link 504 and the second location 516 on the wheel axle 202. In some examples, the first and second cam bolts 520, 522 are integrated into the third link 504 (e.g., proximate the respective third and fourth ends 512, 514). In some examples, the first and second cam bolts 520, 522 enable adjustment of a position and/or orientation of the third link 504 relative to the wheel axle 202 and/or relative to the third radius arm 502. For example, a position of the third end 512 can be adjusted, via the first cam bolt 520, by up to a first example threshold distance (e.g., up to 5 millimeters) from a starting position of the third end 512. Further, a position of the fourth end 514 can be adjusted, via the second cam bolt 522, by up to a second example threshold distance (e.g., up to 5 millimeters) from a starting position of the fourth end 514. While each of the first threshold distance and the second threshold distance are 5 millimeters in this example, at least one of the first threshold distance or the second threshold distance may be different (e.g. less than or greater than 5 millimeters) in some examples.

In the illustrated example of FIG. 5, adjustment of the position of the third link 504 (e.g., via adjustment of the first cam bolt 520 and/or the second cam bolt 522) enables adjustment of an example caster angle 524 associated with the wheel axle 202. For example, concentric movement of the first cam bolts 520 and/or the second cam bolt 522 results in rotation of the wheel axle 202 in the circumferential direction 518 and, thus, results in a change in the caster angle 524. In this example, the caster angle 524 corresponds to an angular displacement between an example steering axis 526 and an example vertical axis 528 of the wheel axle 202 (e.g., where the vertical axis 528 is orthogonal to a ground plane of the vehicle 100 of FIG. 1). In some examples, the caster angle 524 can be adjusted (e.g., via adjustment of the first cam bolt 520 and/or the second cam bolt 522) by up to a threshold amount (e.g., ±1 degree, ±2 degrees, etc.) from a starting caster angle (e.g., an initial caster angle) of the wheel axle 202. In some examples, the first cam bolt 520 and/or the second cam bolt 522 enable adjustment of the caster angle 524 independent of a camber angle associated with the wheel axle 202 (e.g., the caster angle 524 can be adjusted without changing the camber angle).

In some examples, one of the first cam bolt 520 or the second cam bolt 522 may be omitted. Additionally or alternatively, the third linkage 500 can include (e.g., in addition to or instead of the first cam bolt 520 and/or the second cam bolt 522) one or more additional cam bolts coupled between the first end 506 of the third radius arm 502 and the first location 508 on the wheel axle 202 and/or between the second end 510 of the third radius arm 502 and the vehicle frame 103 of the vehicle 100 of FIG. 1.

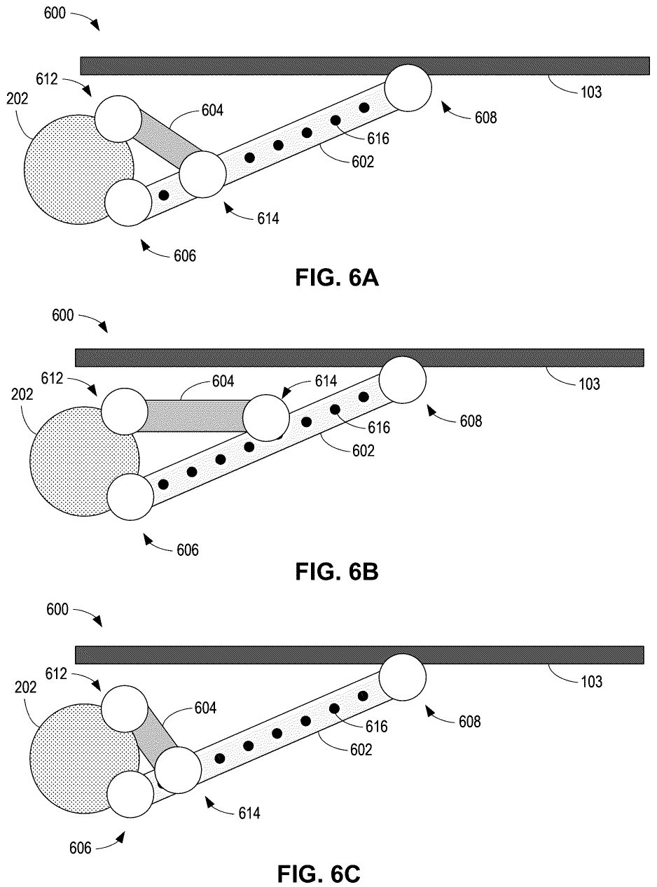

FIGS. 6A, 6B, and 6C are side views of a fourth example linkage 600 (e.g., in a first example configuration, a second example configuration, and a third example configuration, respectively) that may be implemented in the example suspension system 200 of FIGS. 2, 3, 4A, and/or 4B (e.g., instead of one(s) of the first linkage 204A and/or the second linkage 204B of FIGS. 2, 3, 4A, and/or 4B and/or instead of the third linkage 500 of FIG. 5). In the illustrated examples of FIGS. 6A, 6B, and 6C, the fourth linkage 600 includes a fourth example radius arm 602 and a fourth example link 604 coupled to the wheel axle 202. For example, a first end 606 of the fourth radius arm 602 is coupled to the wheel axle 202, and a second end 608 of the fourth radius arm 602 is coupled to the vehicle frame 103 of the vehicle 100 of FIG. 1. Further, a third end 612 of the fourth link 604 is coupled to the wheel axle 202, and a fourth end 614 of the fourth link 604 is coupled to the fourth radius arm 602 (e.g., between the first end 606 and the second end 608).

In the illustrated examples of FIGS. 6A, 6B, and 6C, a location (e.g., an attachment point, a coupling location) on the fourth radius arm 602 at which the fourth end 614 of the fourth link 604 is attached may be adjusted along a length of the fourth radius arm 602 (e.g., between the first end 606 and the second end 608). Stated differently, the fourth end 614 can be coupled to multiple different locations along the length of the fourth radius arm 602. In some examples, the fourth radius arm 602 can include multiple example attachment points (e.g., variable attachment points) 616 along the length of the fourth radius arm 602, and the fourth end 614 can be moved (e.g., manually and/or via one or more actuators) between ones of the attachment points 616 to adjust a position (e.g., an orientation) of the fourth link 604 relative to the fourth radius arm 602. In some examples, in addition to or instead of the attachment points 616, one or more actuators (e.g., the actuator(s) 406 of FIG. 4A) can be operatively coupled to the fourth link 604 to adjust and/or maintain the position of the fourth link 604 (e.g., relative to the fourth radius arm 602). In some examples, one(s) of the attachment points 616 can be positioned in the fourth link 604 (e.g., in addition to and/or instead of the fourth radius arm 602) to enable attachment of the fourth link 604 to the fourth radius arm 602 and/or to the wheel axle 202 at different locations of the fourth link 604.

In some examples, the position of the fourth link 604 can be adjusted to adjust a camber stiffness and/or a roll stiffness of the suspension system 200 (e.g., when the suspension system 200 implements the fourth linkage 600). For example, moving the fourth end 614 of the fourth link 604 closer to the second end 608 of the fourth radius arm 602 (e.g., from the first configuration of FIG. 6A to the second configuration of FIG. 6B) can increase the camber stiffness and/or increase a roll stiffness (e.g., reduce roll freedom) of the suspension system 200. Conversely, moving the fourth end 614 of the fourth link 604 closer to the first end 606 of the fourth radius arm 602 (e.g., from the first configuration of FIG. 6A to the third configuration of FIG. 6C) can reduce the camber stiffness and/or reduce the roll stiffness (e.g., increase the roll freedom) of the suspension system 200. In some examples, the position of the fourth link 604 can be adjusted based on a desired (e.g., target) configuration for the camber stiffness and the roll stiffness of the suspension system 200.

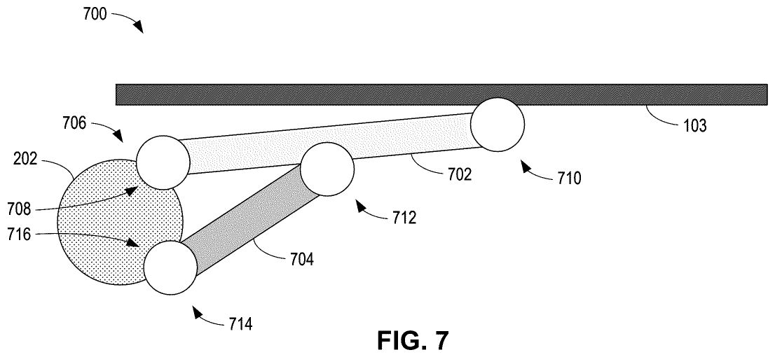

FIG. 7 illustrates a fifth example linkage 700 that may be implemented in the example suspension system 200 of FIGS. 2, 3, 4A, and/or 4B (e.g., in addition to or instead of one(s) of the first linkage 204A and/or the second linkage 204B of FIGS. 2, 3, 4A, and/or 4B, the third linkage 500 of FIG. 5, and/or the fourth linkage 600 of FIGS. 6A, 6B, and/or 6C). In the illustrated example of FIG. 7, the fifth linkage 700 includes a fifth example radius arm 702 and a fifth example link 704 coupled to the wheel axle 202. In this example, a first end 706 of the fifth radius arm 702 is coupled to the wheel axle 202 at a first location 708 on the wheel axle 202, and a second end 710 of the wheel axle 202 is coupled to the vehicle frame 103 of the vehicle 100 of FIG. 1. Further, a third end 712 of the fifth link 704 is coupled to the fifth radius arm 702 between the first end 706 and the second end 710, and a fourth end 714 of the fifth link 704 is coupled to the wheel axle 202 at a second location 716 on the wheel axle 202.

In this example, the first location 708 (e.g., at which the fifth radius arm 702 is coupled to the wheel axle 202) is closer to the vehicle frame 103 than the second location 716 (e.g., at which the fifth link 704 is coupled to the wheel axle 202) is to the vehicle frame 103. As a result, the fifth radius arm 702 is positioned closer to the vehicle frame 103 than the fifth link 704 is to the vehicle frame 103. Stated differently, the fifth linkage 700 of FIG. 7 is in an inverted configuration (e.g., compared to the fourth linkage 600 of FIGS. 6A, 6B, and/or 6C). In some examples, as a result of the fifth linkage 700 of FIG. 7 being in an inverted configuration, the fifth link 704 can absorb a compressive load (or a portion thereof) applied to the wheel axle 202 (e.g., during impact of the wheels 104A, 104B of the vehicle 100 of FIG. 1 with one or more obstacles and/or uneven terrain on a road surface). In some examples, as a result of the inverted configuration, the fifth linkage 700 can increase a ground clearance for the vehicle 100 (e.g., compared to a non-inverted configuration of the fourth linkage 600 of FIGS. 6A, 6B, and/or 6C).

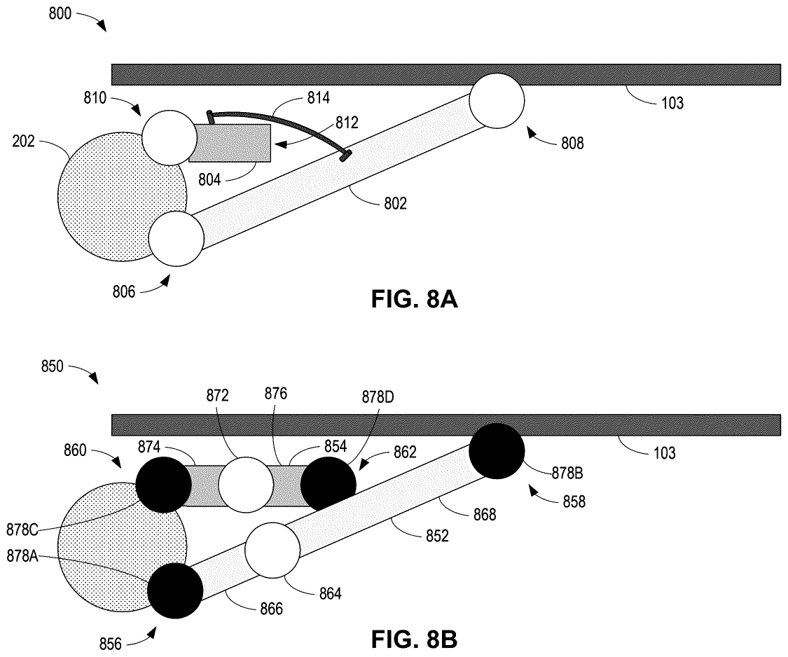

FIG. 8A illustrates a sixth example linkage 800 that may be implemented in the example suspension system 200 of FIGS. 2, 3, 4A, and/or 4B (e.g., in addition to or instead of one(s) of the first linkage 204A and/or the second linkage 204B of FIGS. 2, 3, 4A, and/or 4B, the third linkage 500 of FIG. 5, the fourth linkage 600 of FIGS. 6A, 6B, and/or 6C, and/or the fifth linkage 700 of FIG. 7). In the illustrated example of FIG. 8A, the sixth linkage 800 includes a sixth example radius arm 802 and a sixth example link 804 coupled to the wheel axle 202. In this example, a first end 806 of the sixth radius arm 802 is coupled to the wheel axle 202, a second end 808 of the sixth radius arm 802 is coupled to the vehicle frame 103, a third end 810 of the sixth link 804 is coupled to the wheel axle 202, and a fourth end 812 of the sixth link 804 is coupled to the sixth radius arm 802 via an example flexible member (e.g., a compliant member) 814.

In some examples, the flexible member 814 can include at least one of a spring (e.g., a torsion spring), an elastomeric member, or a cantilever beam. In some examples, the flexible member 814 can be integrally formed with the sixth link 804 and/or the sixth radius arm 802 (e.g., via additive manufacturing). In some examples, the flexible member 814 can reduce a stiffness of the sixth linkage 800 and/or provide additional degree(s) of freedom (e.g., compared to the fourth linkage 600 of FIGS. 6A and/or 6B and/or the fifth linkage 700 of FIG. 7) of the suspension system 200. While the flexible member 814 is coupled between the fourth end 812 of the sixth link 804 and the sixth radius arm 802 in this example, the sixth linkage 800 of FIG. 8A can include, additionally or alternatively, one or more additional flexible members coupled to and/or between one or more components of the sixth linkage 800 (e.g., between the sixth radius arm 802 and the wheel axle 202, between the sixth link 804 and the wheel axle 202, between the sixth radius arm 802 and the vehicle frame 103, etc.).

FIG. 8B illustrates a seventh example linkage 850 that may be implemented in the example suspension system 200 of FIGS. 2, 3, 4A, and/or 4B (e.g., in addition to or instead of one(s) of the first linkage 204A and/or the second linkage 204B of FIGS. 2, 3, 4A, and/or 4B, the third linkage 500 of FIG. 5, the fourth linkage 600 of FIGS. 6A, 6B, and/or 6C, the fifth linkage 700 of FIG. 7, and/or the sixth linkage 800 of FIG. 8A). In the illustrated example of FIG. 8B, the seventh linkage 850 includes a seventh example radius arm 852 and a seventh example link 854 coupled to the wheel axle 202. In this example, a first end 856 of the seventh radius arm 852 is coupled to the wheel axle 202, a second end 858 of the seventh radius arm 852 is coupled to the vehicle frame 103, a third end 860 of the seventh link 854 is coupled to the wheel axle 202, and a fourth end 862 of the seventh link 854 is coupled to the seventh radius arm 852.

In the illustrated example of FIG. 8B, the seventh radius arm 852 includes a first example bushing 864 coupled between a first portion 866 and a second portion 868 of the seventh radius arm 852, and the seventh link 854 includes a second example bushing 872 coupled between a third portion 874 and a fourth portion 876 of the seventh link 854. Further, in this example, the seventh linkage 850 includes example bearings (e.g., spherical bearings) 878A, 878B, 878C, 878D coupled to and/or between respective component(s) of the seventh linkage 850. For example, the first bearing 878A is coupled between the seventh radius arm 852 and the wheel axle 202, the second bearing 878B is coupled between the seventh radius arm 852 and the vehicle frame 103, the third bearing 878C is coupled between the seventh link 854 and the wheel axle 202, and the fourth bearing 878D is coupled between the seventh link 854 and the seventh radius arm 852. In some examples, one(s) of the bushings 864, 872 and/or one(s) of the bearings 878A, 878B, 878C, 878D may be omitted. In some examples, addition of the bushings 864, 872 and/or the bearings 878A, 878B, 878C, 878D can modify (e.g., reduce) a stiffness of the seventh linkage 850.

In some examples, different combination(s) of features described above may be implemented in a suspension system (e.g., the suspension system 200 of FIG. 2) of the vehicle 100 of FIG. 1. For example, any of the linkages included in the suspension system 200 can have a splayed configuration (e.g., as shown in FIGS. 3, 4A, and/or 4B) and/or an inverted configuration (e.g., as shown in FIG. 7). Additionally or alternatively, the suspension system 200 can implement one or more cam bolts (e.g., the cam bolt(s) 520, 522 of FIG. 5), one or more attachment points (e.g., the attachment points 316 of FIG. 3 and/or the attachment points 616 of FIGS. 6A, 6B, and/or 6C), one or more flexible members (e.g., the flexible member 814 of FIG. 8A), one or more bushings (e.g., the bushing(s) 230 of FIG. 2 and/or the bushing(s) 864, 872 of FIG. 8B), and/or one or more bearings (e.g., the bearing(s) 878A, 878B, 878C, 878D of FIG. 8B).

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “substantially,” “approximately,” and “about” modify their subjects/values to recognize the potential presence of variations that occur in real world applications. For example, “substantially,” “approximately,” and “about” may modify dimensions that may not be exact due to manufacturing tolerances and/or other real world imperfections as will be understood by persons of ordinary skill in the art. For example, “substantially,” “approximately,” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time +1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

From the foregoing, it will be appreciated that example systems, apparatus, articles of manufacture, and methods have been disclosed that adjust one or more dynamic properties of a suspension system of a vehicle. An example suspension system disclosed herein includes one or more example linkages, where the linkages include an example radius arm (e.g., a lower control arm) coupled between a wheel axle of the vehicle and a vehicle frame of the vehicle, and an example link (e.g., a support link) coupled between the wheel axle and the radius arm. In some examples, the radius arm and the link are coupled to the wheel axle at respective different locations on the wheel axle, where the locations are spaced apart in a longitudinal direction of the wheel axle (e.g., the radius arm and the link are in a splayed configuration). Additionally or alternatively, in some examples, one or more cam bolts are coupled between the link and the wheel axle and/or between the link and the radius arm. In some examples, position(s) of the link and/or the radius arm (e.g., with respect to the wheel axle) are adjustable via the cam bolt(s) and/or via other adjustment mechanism(s) (e.g., multiple attachment points positioned on the wheel axle and/or the radius arm, one or more actuators operatively coupled to the link and/or the radius arm, etc.).

In some examples, adjusting relative position(s) of the radius arm and/or the link can result in a change in one or more dynamic properties (e.g., roll stiffness, camber stiffness, caster stiffness, degree(s) of freedom, etc.) associated with the suspension system. In particular, some examples disclosed herein enable adjustment of one(s) of the dynamic properties independent of other one(s) of the dynamic properties. As a result, disclosed examples enable a target configuration (e.g., a desired configuration, a target combination) of the dynamic properties to be achieved more easily (e.g., compared to some other suspension system(s)) and, thus, can improve one or more performance characteristics (e.g., vehicle steering and/or handling, vibratory responses to rough and/or uneven terrain, etc.) of the vehicle.

Disclosed systems, apparatus, articles of manufacture, and methods are accordingly directed to one or more improvement(s) in the operation of a machine or other electronic and/or mechanical device.

Example methods, apparatus, systems, and articles of manufacture to adjust one or more dynamic properties of a suspension system of a vehicle are disclosed herein. Further examples and combinations thereof include the following:
Example 1 includes an apparatus comprising a radius arm coupled between a vehicle frame and a wheel axle of a vehicle, a first end of the radius arm coupled to the vehicle frame, a second end of the radius arm coupled to a first location on the wheel axle, and a link coupled between the radius arm and the wheel axle, a third end of the link coupled to the radius arm, a fourth end of the link coupled to the wheel axle at a second location on the wheel axle, the second location adjustable via at least one of (a) a cam bolt coupled between the fourth end of the link and the wheel axle or (b) multiple attachment points on the wheel axle, the multiple attachment points spaced apart in a longitudinal direction of the wheel axle.
Example 2 includes the apparatus of example 1, further including at least one of (a) a first bushing coupled between the first end of the radius arm and the vehicle frame, (b) a second bushing coupled between the second end of the radius arm and the first location, (c) a third bushing coupled between the third end of the link and the radius arm, or (d) a fourth bushing coupled between the fourth end of the link and the second location.
Example 3 includes the apparatus of example 1, wherein the first location is offset from the second location in the longitudinal direction of the wheel axle.
Example 4 includes the apparatus of example 1, wherein the second location is closer to the vehicle frame than the first location is to the vehicle frame.
Example 5 includes the apparatus of example 1, wherein the cam bolt is a first cam bolt, further including a second cam bolt coupled between the third end of the link and the radius arm, the first cam bolt and the second cam bolt to enable adjustment of a caster angle associated with the wheel axle.
Example 6 includes the apparatus of example 1, further including at least one flexible member coupled between the third end of the link and the radius arm, the at least one flexible member including at least one of a spring, an elastomeric member, or a cantilever beam.
Example 7 includes the apparatus of example 1, further including at least one of (a) a first bushing coupled between first and second portions of the radius arm, or (b) a second bushing coupled between third and fourth portions of the link.
Example 8 includes the apparatus of example 1, wherein the first location is closer to a longitudinal center of the wheel axle than the second location is to the longitudinal center.
Example 9 includes an apparatus comprising a radius arm coupled between a vehicle frame and a first location on a wheel axle of a vehicle, and a link coupled between the radius arm and a second location on the wheel axle, the first location offset from the first location in a longitudinal direction of the wheel axle and in a transverse direction of the wheel axle.
Example 10 includes the apparatus of example 9, further including one or more bushings coupled between at least one of (a) the radius arm and the vehicle frame, (b) the radius arm and the wheel axle, (c) the link and the radius arm, or (d) the link and the wheel axle.
Example 11 includes the apparatus of example 9, wherein a first distance between the first location and a midpoint of the wheel axle is less than a second distance between the second location and the midpoint.
Example 12 includes the apparatus of example 9, further including one or more cam bolts coupled between at least one of (a) the link and the radius arm or (b) the link and the wheel axle, the one or more cam bolts to enable adjustment of a position of the link with respect to the radius arm.
Example 13 includes the apparatus of example 9, wherein the wheel axle includes multiple attachment points spaced apart along a length of the wheel axle, the second location corresponding to one of the multiple attachment points.
Example 14 includes the apparatus of example 9, further including an electromechanical actuator coupled to the link, the electromechanical actuator to enable adjustment of a position of the link with respect to the radius arm.
Example 15 includes an apparatus comprising a radius arm coupled between a vehicle frame and a first location on a wheel axle of a vehicle, a link coupled between the radius arm and a second location on the wheel axle, the second location different from the first location, and one or more cam bolts coupled between at least one of (a) the link and the second location or (b) the link and the radius arm, the one or more cam bolts to enable adjustment of a position of the link with respect to the wheel axle and the radius arm.
Example 16 includes the apparatus of example 15, wherein the second location is spaced apart from the first location in a longitudinal direction of the wheel axle.
Example 17 includes the apparatus of example 16, wherein a distance along the longitudinal direction between the first location and the second location is up to 60 millimeters.
Example 18 includes the apparatus of example 15, further including at least one of a spring, an elastomeric member, or a cantilever beam coupled between the link and the radius arm.
Example 19 includes the apparatus of example 15, wherein the first location and the second location are spaced apart in a transverse direction of the wheel axle, the first location closer to the vehicle frame than the second location is to the vehicle frame.
Example 20 includes the apparatus of example 15, wherein the one or more cam bolts enable adjustment of a caster angle associated with the wheel axle by up to 1 degree from a starting caster angle.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
a radius arm coupled between a vehicle frame and a wheel axle of a vehicle, a first end of the radius arm coupled to the vehicle frame, a second end of the radius arm coupled to a first location on the wheel axle; and
a link coupled between the radius arm and the wheel axle, a third end of the link coupled to the radius arm, a fourth end of the link coupled to the wheel axle at a second location on the wheel axle, the wheel axle including multiple fixed attachment points spaced apart in a longitudinal direction of the wheel axle, a distance, in the longitudinal direction, between the first location and the second location adjustable by coupling of the fourth end of the link to different ones of the multiple fixed attachment points.

2. The apparatus of claim 1, further including at least one of (a) a first bushing coupled between the first end of the radius arm and the vehicle frame, (b) a second bushing coupled between the second end of the radius arm and the first location, (c) a third bushing coupled between the third end of the link and the radius arm, or (d) a fourth bushing coupled between the fourth end of the link and the second location.

3. The apparatus of claim 1, wherein the first location is offset from the second location in the longitudinal direction of the wheel axle.

4. The apparatus of claim 1, wherein the second location is closer to the vehicle frame than the first location is to the vehicle frame.

5. The apparatus of claim 1, further including a cam bolt coupled between the third end of the link and the radius arm, the cam bolt to enable adjustment of a caster angle associated with the wheel axle.

6. The apparatus of claim 1, further including at least one flexible member coupled between the third end of the link and the radius arm, the at least one flexible member including at least one of a spring, an elastomeric member, or a cantilever beam.

7. The apparatus of claim 1, further including at least one of (a) a first bushing coupled between first and second portions of the radius arm, or (b) a second bushing coupled between third and fourth portions of the link.

8. The apparatus of claim 1, wherein the first location is closer to a longitudinal center of the wheel axle than the second location is to the longitudinal center.

9. An apparatus comprising:
a radius arm coupled between a vehicle frame and a first location on a wheel axle of a vehicle; and
a link coupled between the radius arm and a second location on the wheel axle, the second location offset from the first location in a longitudinal direction of the wheel axle and in a transverse direction of the wheel axle, the wheel axle including multiple fixed attachment points spaced apart in the longitudinal direction, a distance, in the longitudinal direction, between the first location and the second location adjustable by coupling of the link to different ones of the multiple fixed attachment points.

10. The apparatus of claim 9, further including one or more bushings coupled between at least one of (a) the radius arm and the vehicle frame, (b) the radius arm and the wheel axle, (c) the link and the radius arm, or (d) the link and the wheel axle.

11. The apparatus of claim 9, wherein the distance is a first distance, and a second distance between the first location and a midpoint of the wheel axle is less than a third distance between the second location and the midpoint.

12. The apparatus of claim 9, further including one or more cam bolts coupled between at least one of (a) the link and the radius arm or (b) the link and the wheel axle, the one or more cam bolts to enable adjustment of a position of the link with respect to the radius arm.

13. The apparatus of claim 9, wherein the multiple fixed attachment points are substantially evenly spaced apart along a length of the wheel axle.

14. The apparatus of claim 9, further including an electromechanical actuator coupled to the link, the electromechanical actuator to enable adjustment of a position of the link with respect to the radius arm.

15. An apparatus comprising:
a radius arm coupled between a vehicle frame and a first location on a wheel axle of a vehicle, the radius arm including multiple attachment points along a length of the radius arm;
a link coupled between the radius arm and a second location on the wheel axle, the second location different from the first location, the link coupled to the radius arm at a third location on the radius arm, the third location adjustable via the multiple attachment points; and
one or more cam bolts coupled between at least one of (a) the link and the second location or (b) the link and the radius arm, the one or more cam bolts to enable adjustment of a position of the link with respect to the wheel axle and the radius arm.

16. The apparatus of claim 15, wherein the second location is spaced apart from the first location in a longitudinal direction of the wheel axle.

17. The apparatus of claim 16, wherein a distance along the longitudinal direction between the first location and the second location is up to 60 millimeters.

18. The apparatus of claim 15, further including at least one of a spring, an elastomeric member, or a cantilever beam coupled between the link and the radius arm.

19. The apparatus of claim 15, wherein the first location and the second location are spaced apart in a transverse direction of the wheel axle, the first location closer to the vehicle frame than the second location is to the vehicle frame.

20. The apparatus of claim 15, wherein the one or more cam bolts enable adjustment of a caster angle associated with the wheel axle by up to 1 degree from a starting caster angle.
